(19) United States
(12) Patent Application Publication
(10) Pub. No.: US 2025/0167474 A1
(43) Pub. Date: May 22, 2025

(54) SWINGABLE ERROR-TOLERANT CONNECTOR AND SWINGABLE ERROR-TOLERANT FLOATING CONNECTOR

(71) Applicant: DONGGUAN LJV TECHNOLOGY CO., LTD, DONGGUAN (CN)

(72) Inventor: CUNKA YANG, DONGGUAN (CN)

(21) Appl. No.: 19/031,397

(22) Filed: Jan. 18, 2025

Related U.S. Application Data
(63) Continuation of application No. PCT/CN2023/070914, filed on Jan. 6, 2023.

(30) Foreign Application Priority Data
Jul. 20, 2022 (CN) 202210863702.7
Oct. 30, 2022 (CN) 202222871787.1

(51) Int. Cl. H01R 12/91; H01R 13/11; H01R 13/41; H01R 13/502

(52) U.S. Cl. CPC H01R 12/91; H01R 13/113; H01R 13/41; H01R 13/502

(57) ABSTRACT

Disclosed in the present application is a swingable error-tolerant connector. The swingable error-tolerant connector includes a fixed base, an insulator, and a conductive terminal, where the insulator is floatingly supported on the fixed base through the conductive terminal, and a flexible portion for floatingly supporting the insulator to translate and/or swing is arranged on the conductive terminal.

### CROSS-REFERENCE TO RELATED APPLICATIONS

This application is a continuation application of International Application No. PCT/CN2023/070914, filed on Jan. 6, 2023, Which claim priority to Chinese Patent Application No. CN202210863702.7, filed on Jul. 20, 2022, and Chinese Patent Application No. CN202222871787.1, filed on Oct. 30, 2022. The disclosures of the aforementioned patent applications are hereby incorporated by reference in their entireties.

### TECHNICAL FIELD

The present application relates to the technical field of connectors, and in particular to a swingable error-tolerant connector.

### DESCRIPTION OF RELATED ART

The statement here only provides background information related to the present application and does not necessarily constitute the prior art.

With the rapid development of the communication industry and various electronic and electrical appliances, connectors are widely used in various circuits. The connector typically includes a housing made of an insulative material and a plurality of terminals made of conductive materials. Each terminal is arranged on the housing of the connector, an end portion of which is electrically connected to a circuit board.

An existing floating connector is provided with a fixed-side housing fixed to a circuit board, a floating-side housing having an embedment portion embeddable into a mating connector, and a contact maintained across the fixed-side housing and the floating-side housing. The floating-side housing is movable relative to the fixed-side housing through elastic deformation of the contact, so as to tolerate a deviation between the circuit boards or a deviation from an embedment position of the mating connector.

The existing floating connector has the following shortages: 1. According to a floating principle of the existing floating connector, terminals on one side are compressed while corresponding terminals on the other side are stretched; a floating portion is able to translate; a tolerance is fully dependent on an interval space between a fixed base and the floating portion; and when a large tolerance is required, the interval space has to be expanded, and therefore a larger area of the circuit board will be occupied. 2. The existing floating connector has limited adaptability to an angle deviation. 3. According to an existing floating solution, high residual stress remains in the terminals after an insertion is completed because the floating portion translates as a whole and all the terminals must be compressed or stretched. 4. In the existing floating solution, a male terminal and a female terminal are only in one-sided contact in a single circuit, and therefore the reliability against harsh environments is unsatisfactory.

### SUMMARY

In order to realize the above objectives, a swingable error-tolerant connector is disclosed in the present application. The swingable error-tolerant connector includes a fixed base, an insulator, and a conductive terminal, where the insulator is floatingly supported on the fixed base through the conductive terminal, and a flexible portion for floatingly supporting the insulator to translate and/or swing is arranged on the conductive terminal.

The conductive terminal of the swingable error-tolerant connector is swingable along with the insulator to adapt to non-coaxial and misaligned deviations between a male connector and a female connector caused by an assembly error. Accordingly, the structural stability after an external insert is inserted into the swingable error-tolerant connector can be effectively ensured, the damage to the swingable error-tolerant connector and/or a terminal of the external insert and remaining parts due to insertion deviations in an insertion process can be avoided, and the swingable error-tolerant connector is simple in structure and convenient to use.

A swingable error-tolerant floating connector realizing mating guide for conductive terminals is further provided by the present application. The swingable error-tolerant floating connector includes a connector and an external insert; where the connector includes a floating insulator, a plurality of insertion holes are provided on the floating insulator, and first conductive terminals are fixedly clamped into the insertion holes; the external insert is provided with second conductive terminals capable of being inserted into the insertion holes and establishing insert connection to the first conductive terminals, and the plurality of second conductive terminals correspond one-to-one to the plurality of first conductive terminals; and cambered guide structures or sloped guide structures capable of converting interaction forces between the second conductive terminals and the insertion holes into forces to push the floating insulator to be adjusted floatingly during cooperation are arranged between the second conductive terminals and the insertion holes.

In a mating process, a spherical crown structure on an upper end of the floating insulator guides the floating insulator into a recess on a lower end of the external insert and is in movable fit with the recess to realize relative sliding and swinging. Further, an inclined sliding guide surface is in sliding fit with a sloped sliding guide surface, specifically, a sliding guide structure on an upper end of the insertion hole is a through hole section having a larger outer port and a smaller inner port, the sloped sliding guide surface having an inner diameter gradually reduced is arranged between an upper end and a lower end of a through hole, and the inclined sliding guide surface configured to guide an insertion pin into the insertion hole is arranged on a top end of the insertion pin, so that a sliding guide action is implemented in the mating process. In a sliding process, the sliding guide structure floats towards one side after being pressed by the sloped sliding guide surface, so that an interaction force is converted into a force to push the floating insulator to be adjusted towards one side floatingly. After floating adjustment of the floating insulator is completed, the plurality of second conductive terminals can be smoothly axially inserted into the corresponding insertion holes, and the insertion pins can also be guided to be smoothly inserted into the insertion holes under an eccentric state of the second conductive terminals and the insertion holes. Accordingly, the defect that an insertion pin is likely to be broken due to eccentricity generated when a circular-shaft insertion pin cooperates with a circular mounting hole in the prior art is avoided. The swingable error-tolerant floating connector is simpler in structure and higher in cooperation stability.

### BRIEF DESCRIPTION OF THE DRAWINGS

FIG. 1 is a first schematic structural diagram in Example 1 of the present application;

FIG. 2 is a second schematic structural diagram in Example 1 of the present application;

FIG. 3 is a schematic structural diagram in Example 2 of the present application;

FIG. 4A is a sectional schematic structural diagram of an insulator and an external insert in direction C-C in FIG. 3;

FIG. 4B is a schematic structural diagram of the insulator in FIG. 4A after a horizontal slip and left-and-right deflection;

FIG. 5 is a first schematic structural diagram in Example 3 of the present application;

FIG. 6 is a second schematic structural diagram in Example 3 of the present application;

FIG. 7 is an enlarged diagram of portion A in FIG. 6;

FIG. 8 is an enlarged diagram of portion B in FIG. 6;

FIG. 9 is a schematic structural diagram of a fixed base in an example of the present application;

FIG. 10 is a first schematic structural diagram of a conductive terminal of the present application;

FIG. 11 is a second schematic structural diagram of a conductive terminal of the present application;

FIG. 12 is a third schematic structural diagram of a conductive terminal of the present application;

FIG. 13 is a fourth schematic structural diagram of a conductive terminal of the present application;

FIG. 14 is a fifth schematic structural diagram of a conductive terminal of the present application;

FIG. 15 is a sixth schematic structural diagram of a conductive terminal of the present application;

FIG. 16 is a first schematic structural diagram of a spherical support point of an insulator of the present application;

FIG. 17 is a second schematic structural diagram of a spherical support point of an insulator of the present application;

FIG. 18 is a third schematic structural diagram of a spherical support point of an insulator of the present application;

FIG. 19 is a schematic diagram of a three-dimensional structure of a connector in Example 4 of the present application;

FIG. 20 is an exploded schematic structural diagram in Example 4;

FIG. 21 is a first schematic structural diagram showing floating in a short edge direction of a floating insulator when an external insert is inserted into Example 4;

FIG. 22 is a second schematic structural diagram showing floating in a short edge direction of a floating insulator when an external insert is inserted into Example 4;

FIG. 23 is a first schematic structural diagram showing floating in a long edge direction of a floating insulator when an external insert is inserted into Example 4;

FIG. 24 is a second schematic structural diagram showing floating in a long edge direction of a floating insulator when an external insert is inserted into Example 4;

FIG. 25 is a schematic structural diagram of floating intervals between four sides of a floating insulator and fixed base holes in Example 4;

FIG. 26 is a cross-sectional view in direction A-A in FIG. 7;

FIG. 27 is a schematic diagram of a three-dimensional structure of a connector in Example 5 of the present application;

FIG. 28 is an exploded schematic structural diagram in Example 5;

FIG. 29 is a schematic diagram of a three-dimensional structure of a connector in Example 6;

FIG. 30 is a front view in Example 6;

FIG. 31 is an exploded schematic structural diagram in Example 6; and

FIG. 32 is a schematic structural diagram of a sloped guide structure of the present application.

### DETAILED DESCRIPTION OF EMBODIMENTS

In order to facilitate understanding of the present application, the present application will be explained in more detail below with reference to the accompanying drawings and specific embodiments. It should be noted that when an element is expressed to be “fixed” to another element, the element may be directly on the other element, or there may be one or more medium elements between them. When an element is expressed to be “connected” to another element, the element may be directly connected to the other element, or there may be one or more medium elements between them. The terms “vertical”, “horizontal”, “left”, “right”, “inner”, “outer”, and similar expressions used in the specification are merely for illustrative purposes. In the description of the present application, the terms “first” and “second” are merely used for descriptive purposes and cannot be understood as indicating relative importance or implying a quantity of indicated technical features. Therefore, unless otherwise specified, features limited to “first” or “second” may explicitly or implicitly include one or more of these features; and the meaning of “a plurality of” is two or more. The term “include” and any variations thereof mean non-exclusive inclusion, which may include or add one or more other features, integers, steps, operations, units, components, and/or combinations thereof.

In addition, unless otherwise specified and limited, the terms “mounted”, “connected”, and “connection” should be understood broadly, for example, the “connection” may be fixed connection, detachable connection, integral connection, mechanical connection, electrical connection, direct connection, or connection by a medium, or internal communication between two elements. All technical and scientific terms used in the specification have the same meanings as those commonly understood by those skilled in the art. The terms used in the specification of the present application are merely for the purpose of describing specific embodiments and are not intended to limit the present application. The term “and/or” used in the specification includes any and all combinations of one or more relevant listed items.

Moreover, the technical features involved in different embodiments of the present application described below can be combined with each other as long as they do not conflict with each other.

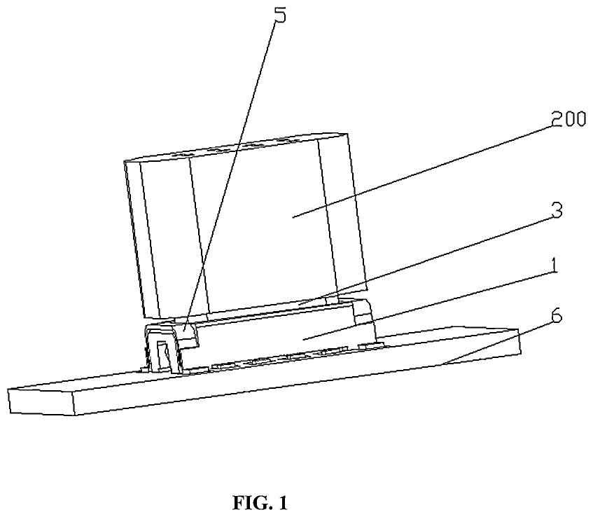

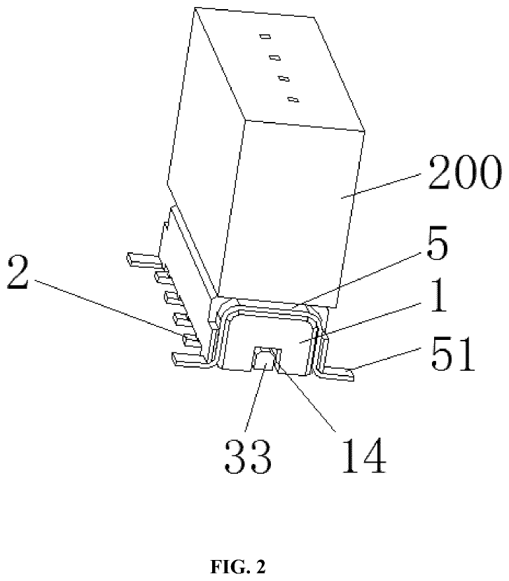

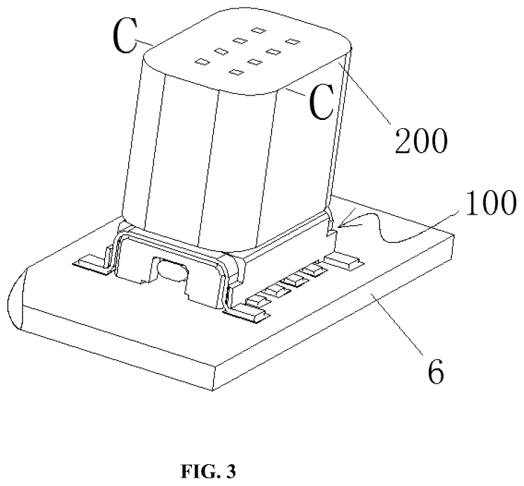

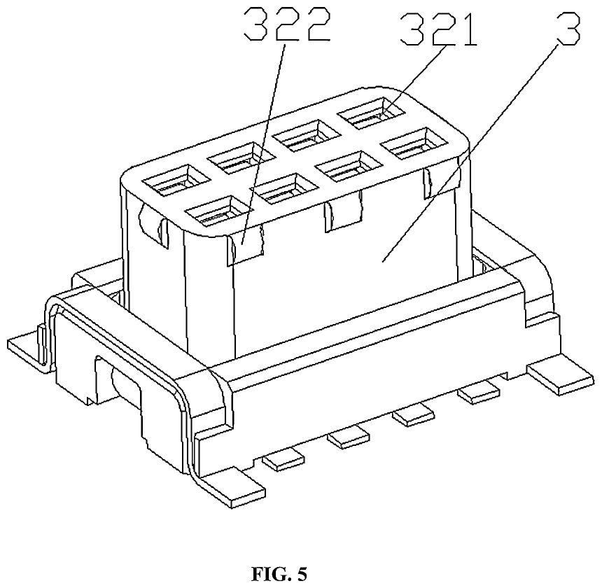

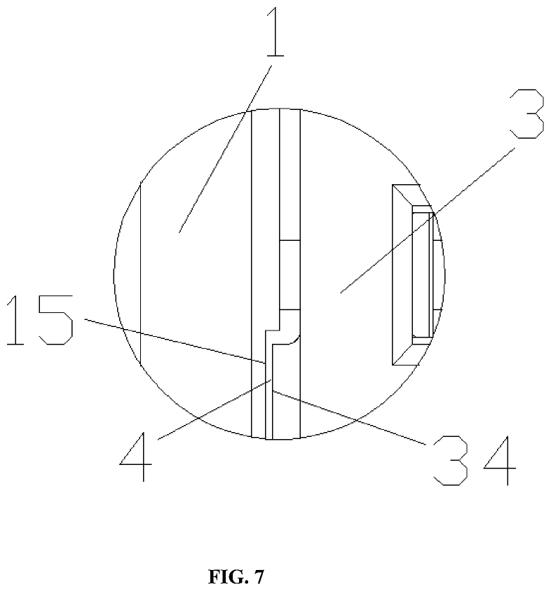

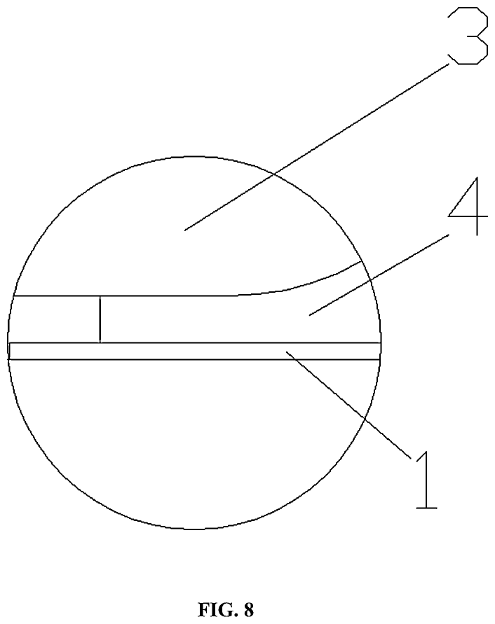

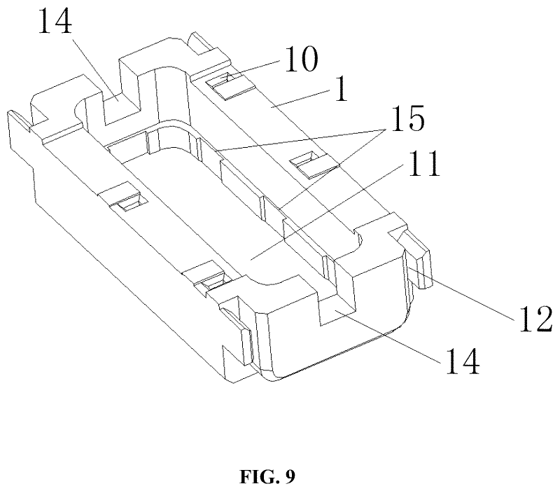

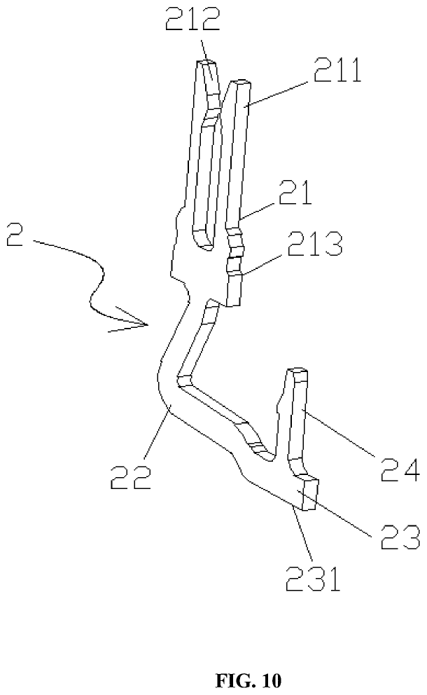

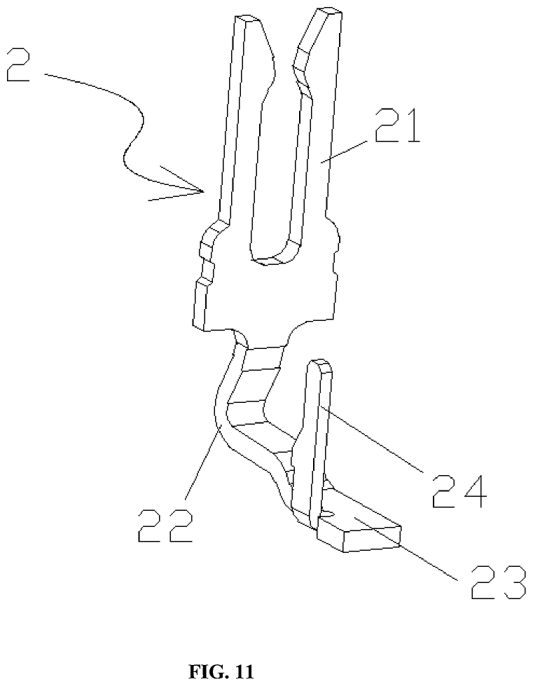

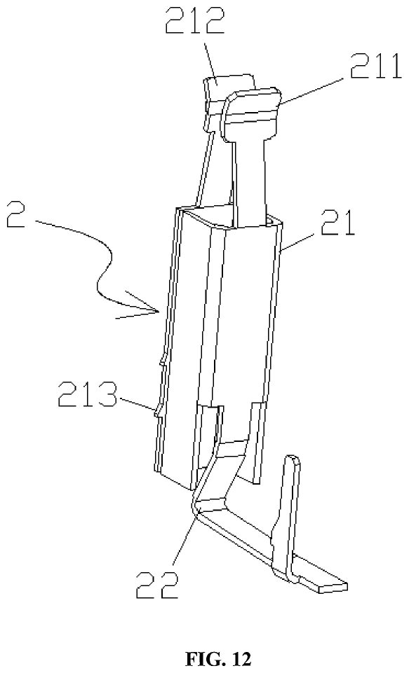

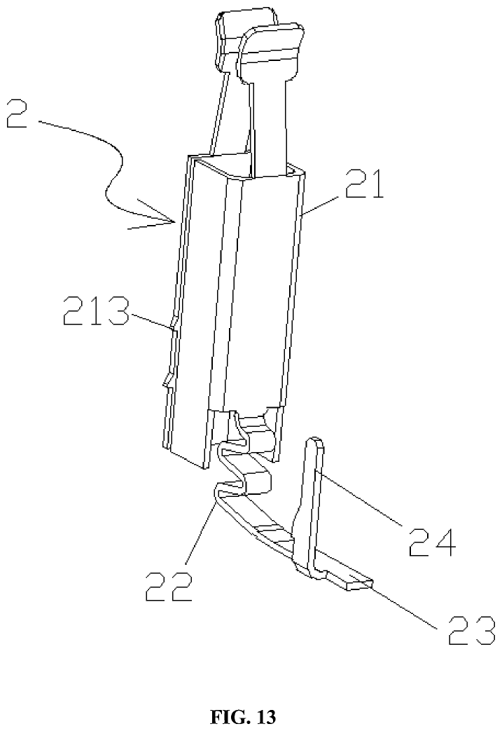

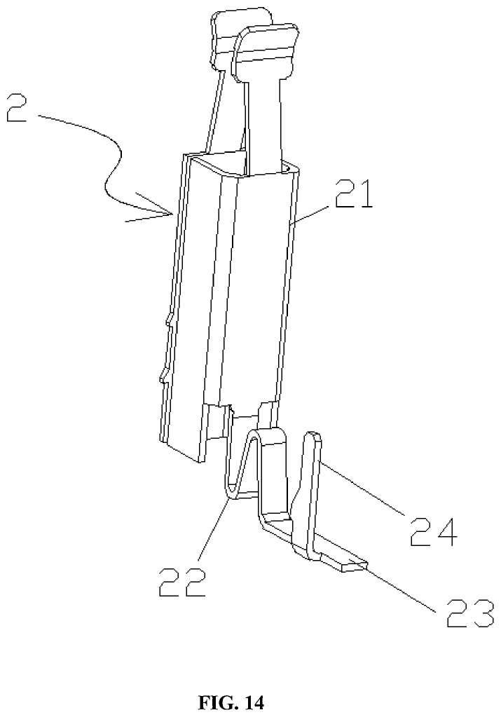

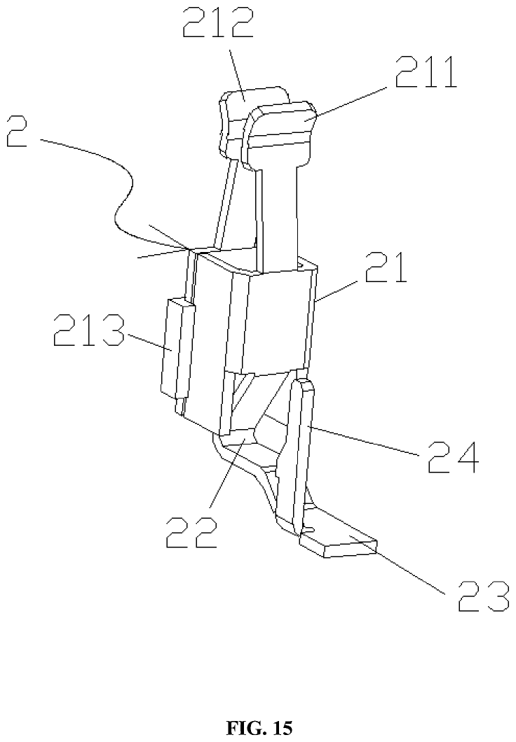

As shown in FIGS. 1-18, a swingable error-tolerant connector includes a fixed base 1, a conductive terminal 2, and an insulator 3, where the conductive terminal 2 is divided into an insertion body 21, a flexible portion 22, and a terminal pin 23 in sequence from top to bottom, the terminal pin 23 is provided with a retaining portion 24 capable of being inserted into the fixed base 1, and the insulator 3 is floatingly supported on the fixed base 1 through the insertion body 21, the flexible portion 22, and the retaining portion 24.

In the present application, the flexible portion 22 is configured to floatingly support the insulator 3 in floating such as translation and/or swinging relative to the fixed base 1. Therefore, the insulator is floatingly supported on the fixed base through the conductive terminal, facilitating stable cooperation between a connector 100 and an external insert 200 in a deviated state.

In the example of the present application, the insertion body 21 and the terminal pin 23 are flexibly arranged through the flexible portion 22. A specific structure is configured in such a way that the flexible portion 22 is an elastic welding pin sheet having a flexible deformation structure, and the elastic welding pin sheet is bent in right angle, an acute angle, a single wave, or multiple waves. The flexible deformation structure of the flexible portion 22 may be in various forms. The change of the flexible deformation structure of the flexible portion 22 does not affect the scope of protection of the present application.

In the present application, the fixed base 1 is provided with a deflection space 11 for the insulator 3 to deflect, the insulator 3 is suspended in the deflection space 11, an interval space 4 is provided between the insulator 3 and the fixed base 1 for the insulator 3 to deflect in a reciprocating manner, and the interval space 4 is configured to limit a deflection angle range of the insulator 3 in order to further improve the stability of rotary cooperation between the connector 100 and the external insert 200.

During insert connection, the interval space 4 is provided between the insulator 3 and the fixed base 1 for the insulator 3 to deflect in the reciprocating manner, so that the insertion body 21 deflects back and forth in the deflection space along with the insulator 3. That is, under action of an external force, the insertion body 21 may realize mixed floating of translation and/or swinging in the deflection space 11, so that the insulator 3 and an elastic female terminal contact sheet on the insertion body 21 can adapt to deviations caused by non-coaxial and misaligned connection of the connector 100 and the external insert 200 through translation and/or swinging. Accordingly, a horizontal deviation and an angular deviation in the insertion process can be overcome, the structural stability after the external insert 200 is inserted into the connector 100 can be effectively ensured, and damage to the connector 100 and/or a terminal of the external insert 200 and remaining parts due to insertion deviations in the insertion process can be avoided. The swingable error-tolerant connector is simple in structure and convenient to use.

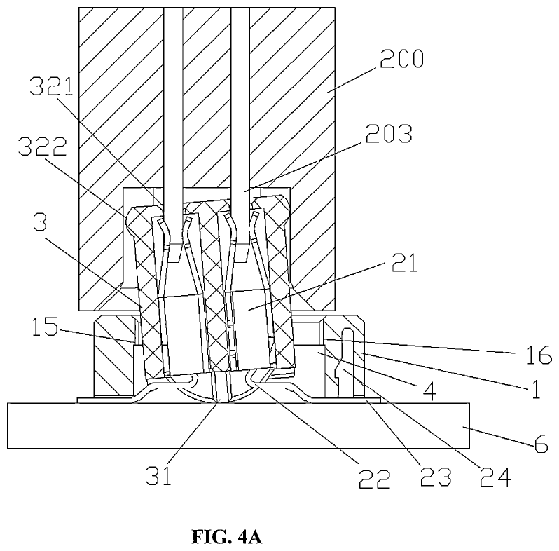

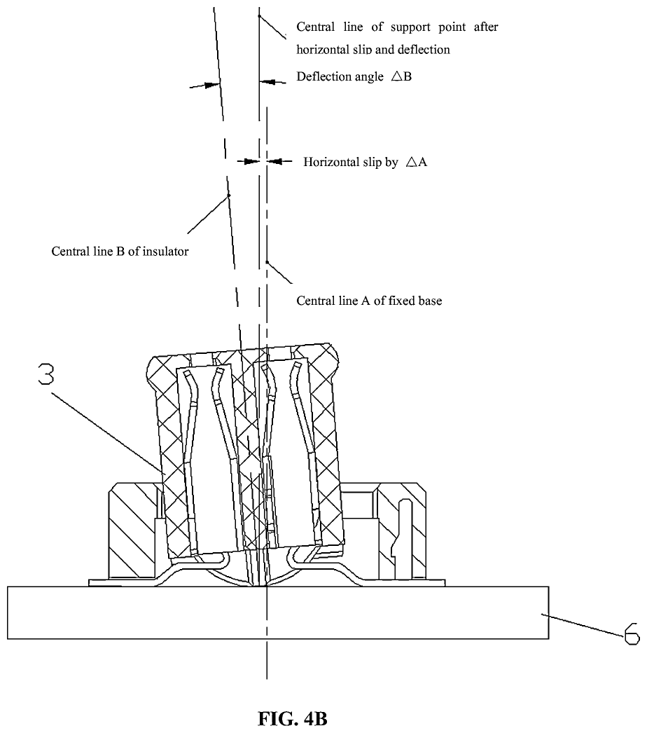

An initial position is formed when the insulator 3 and the fixed base 1 are concentric. In this case, a central line A of the fixed base and a central line B of the insulator are positioned on a central plane extending in a front-and-rear direction. In the examples shown in FIGS. 4A and 4B, when the deviations caused by non-coaxial and misaligned connection of the connector 100 and the external insert 200 are generated, the insulator 3 is pulled by the external insert 200 to horizontally slip by ΔA leftwards, and simultaneously, an end socket 32 on the insulator 3 is moved by a deflection angle ΔB leftwards. Accordingly, the end socket 32 and the elastic female terminal contact sheet on the insertion body 21 can adapt to the deviations caused by the non-coaxial and misaligned connection of the connector 100 and the external insert 200 through translation and swinging, and the horizontal deviation and the angular deviation in the insertion process can be overcome.

In the present application, when the external insert 200 is pulled out from the connector 100, the external force applied to the insulator 3 is released. The insulator 3 floats reversely and restores under action of an elastic force generated when the flexible portion 22 is restored from deformation, so that next insert connection is facilitated.

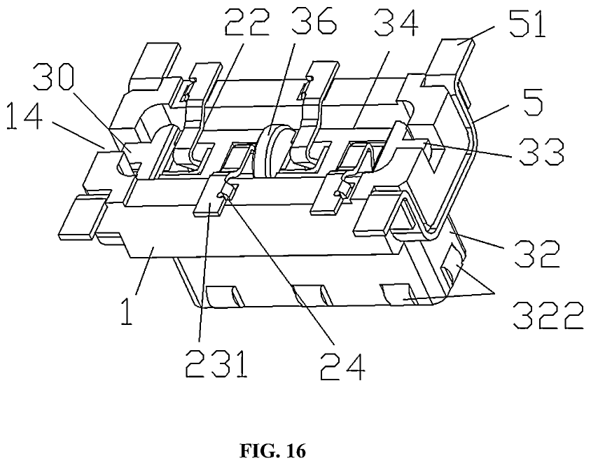

In the examples of the present application shown in FIGS. 16-18, a bottom of the insulator 3 is provided with a spherical support point 31 or a cambered support point 36 for supporting the insulator 3 to perform angular deflection and restoration.

The spherical support point 31 is a spherical support point formed by two arc sections intersecting each other in an X direction and a Y direction. The cambered support point 36 is a cambered support point formed by a single arc segment or a plurality of parallel arc segments arranged at intervals in the X direction or the Y direction.

The spherical support point 31 or the cambered support point 36 is configured to support a downward pressing force applied to the insulator 3 by the external insert 200 during insertion. Accordingly, the insulator 3 is prevented from being pulled through downward movement and damaging a welding spot between the terminal pin 23 and the fixed base 1. Moreover, the contact between the spherical support point 31 or the cambered support point 36 and a support surface is the contact between a spherical surface or a cambered surface and a plane. Such a structural design enables the insulator 3 to roll and/or slide on the support surface in the deflection process of translation and/or swinging of the insulator 3 in the deflection space 11. That is, in the present example, the insulator 3 may roll and/or slide on a connection plate 6, so that a butt-joint angle of the insulator 3 and the insertion body 21 thereon can be automatically adjusted in the deflection space 11 relying on a mutual pressing external force butt-joint of a male connector and a female connector, and the structural stability after the external insert 200 is inserted into the connector 100 can be ensured.

In the example of the present application, an upper end of the insulator 3 is provided with the end socket 32 configured to establish insert connection to the external insert 200, the end socket 32 is provided with an insert connection hole 321, and the insertion body 21 is fixedly mounted in the insert connection hole 321; and the elastic female terminal contact sheet on an upper end of the insertion body 21 is arranged in the insert connection hole 321 and is close to an upper port of the insert connection hole 321, a lower side of an outer end of the terminal pin 23 is provided with a terminal welding surface 231, and the terminal soldering surface 231 is configured to be welded to the connection plate 6.

In the example of the present application, protruding cambered guide structures 322 configured to guide the external insert 200 to establish insert connection to the end socket 32 are arranged on four sides of the end socket respectively 32. A plurality of cambered guide structures 322 form a spherical crown surface structure capable of being in sliding fit with the external insert. The cambered guide structures 322 are protruding spherical crowns. Through the cambered guide structures 322, the end socket 32 is swingable in the external insert 200 while the external insert 200 can sleeve the end socket 32 along a protruding smooth spherical surface. When the external insert 200 is guided to establish insert connection to the end socket 32 through the cambered guide structures 322, the end socket 32 is swingable in the external insert 200 through the spherical crown surface structure formed by the plurality of cambered guide structures 322, so that an insert angle of the end socket 32 is adjustable.

Except for the above examples, the above function may also be realized through a spherical cap-shaped end socket (not shown), which is structurally configured as follows: the end socket is provided with a bigger end, and a periphery of the bigger end is in a spherical crown shape; and when the external insert is guided to establish insert connection to the end socket through the bigger end, the end socket is swingable in the external insert through a spherical crown surface of the bigger end, so that an insert angle of the end socket is adjustable.

In the example of the present application, the elastic female terminal contact sheet on the insertion body 21 is an elastic female terminal contact sheet with offset tolerance. In the present example, a specific structure is configured in such a way that: the upper end of the insertion body 21 is provided with two elastic terminal sheets 211 oppositely arranged, a receiving cavity 212 provided with two opposite side openings for terminals 203 of the external insert 200 to be inserted is formed between the two elastic terminal sheets 211, and an interval between the elastic terminal sheets 211 oppositely arranged is formed into a female terminal tolerance interval capable of tolerating an error of insert connection of the terminals 203 of the external insert 200. During the insert connection, there are two connection states as follows:

In a first connection state, when the external insert 200 directly faces the end socket 32 and establishes insert connection to same, the terminals 203 of the external insert 200 are inserted into the receiving cavity 212, and the two elastic terminal sheets 211 jointly grip the terminals 203 of the external insert 200, so that stable electric connection between the connector 100 and the external insert 200 is ensured.

In a second state, when the external insert 200 establishes insert connection to the end socket 32 in a deflected state, the female terminal tolerance interval enables the terminals 203 of the external insert 200 to protrude out of the receiving cavity 212 through one of the two opposite side openings for the insert connection. That is, the terminals 203 of the external insert 200 are arranged in the insert connection holes 321. Some terminals 203 of the external insert 200 are exposed outside the receiving cavity 212, but remaining terminals are still electrically connected to the two elastic terminal sheets 211 on the receiving cavity 212.

Except for the two elastic terminal sheets 211 arranged, a plurality of pairs, for example, two pairs or three pairs, of elastic terminal sheets 211 may be arranged. The change in the number of elastic terminal sheets 211 is not to limit the scope of protection of the present application.

In the example of the present application, the retaining portion 24 is a barbed portion, and a lower end of the fixed base 1 is provided with a clamping groove 10 capable of being in clamping connection to the barbed portion. The barbed portion is fixedly clamped into the clamping groove to enhance the connection stability between the terminal pin 23 and the fixed base 1 and prevent the terminal pin 23 from being damaged by flexible deformation of the flexible portion 22.

In the example of the present application, the insert connection hole 321 is a square hole, the insertion body 21 is provided with a clamping portion capable of being clamped into the insert connection hole. Through cooperation between the clamping portion and the square hole, the conductive terminal can be prevented from rotating circumferentially relative to the insert connection hole. Therefore, the assembly stability between the conductive terminal 1 and the insulator 3 can be enhanced.

The insert connection hole 321 may also take other special-shaped hole forms to be in clamping fit with the insertion body 21. The change in the cooperation structure between the insert connection hole 321 and the insertion body 21 is not to limit the scope of protection of the present application.

A further improvement is as follows: one side of an outer wall of the clamping portion is provided with protrusions 213 capable of pressing an inner wall of the insert connection hole 321 to reinforce mounting of the insertion body 21 in the insert connection hole. The protrusions 213 can further enhance the assembly stability of the insertion body 21 and avoid assembly looseness.

A further improvement is as follows: a plurality of protrusions 213 are provided, and the plurality of protrusions 213 are arranged at intervals in a vertical direction along the clamping portion. The plurality of protrusions 213 further enhance the assembly stability of the insertion body 21.

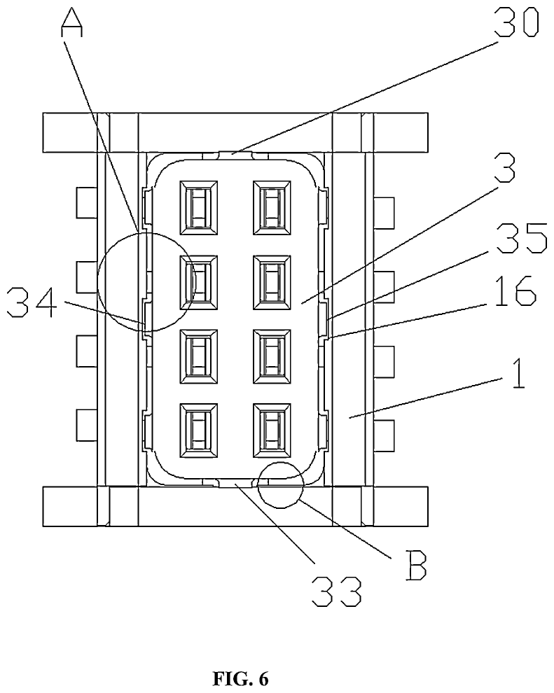

In the example shown in FIG. 6 of the present application, an interval space 4 is divided into a front interval space, a rear interval space, a left interval space, and a right interval space positioned between the four sides of the insulator 3 and the fixed base 1 respectively, and limiting structures for limiting a reciprocating deflection angle of the insulator 3 are arranged between the fixed base 1 and the four sides of the insulator 3.

In the example shown in FIG. 6 of the present application, the insulator 3 is in a block shape, the fixed base 1 is in a frame shape, and the four sides of the insulator 3 are provided with a front hanging lug 30, a rear hanging lug 33, a left blocking edge 34, and a right blocking edge 35 respectively. The front hanging lug 30 and the rear hanging lug 33 are symmetrically arranged on a front end and a rear end of the insulator 3 respectively, and the left blocking edge 34 and the right blocking edge 35 are symmetrically arranged on a left side and a right side of the insulator 3 respectively.

A specific structure is as follows:

A front end and a rear end of the fixed base 1 are provided with n-shaped openings 14 respectively, the front end and the rear end of the insulator 3 are symmetrically provided with the front hanging lug 30 and the rear hanging lug 33 respectively, and the front hanging lug 30 and the rear hanging lug 33 protrude into the n-shaped openings 14 on the front end and the rear end correspondingly. A gap for the front hanging lug 30 to swing is reserved between the front hanging lug 30 and an inner wall of the n-shaped opening 14 on the front end, and a gap for he front hanging lug 30 to swing is reserved between the rear hanging lug 33 and an inner wall of the n-shaped opening 14 on the rear end. The movement of the front hanging lug 30 and the rear hanging lug 33 is limited through an upper edge, a left edge, and a right edge of the n-shaped opening 14 on the front end and an upper edge, a left edge, and a right edge of the n-shaped opening on the rear end respectively. The upper edges of the n-shaped openings 14 limit a limit deflection angle range of the insulator 3 in the front-and-rear direction. The left edges and the right edges of the n-shaped openings 14 principally limit translation ranges of the front hanging lug 30 and the rear hanging lug 33 in the left-and-right direction.

A left side and a right side of the upper end of the fixed base 1 are provided with a left blocking wall 15 and a right blocking wall 16 respectively. A forward-direction swinging limit of the left blocking edge 34 is limited to the left blocking wall 15, and a reverse-direction swinging limit of the right blocking edge 35 is limited to the right blocking wall 16. Therefore, the limit deflection angle range of the insulator is limited in the left-and-right direction.

Expect for the example shown in FIG. 6, the following structural designs may also be employed:

In the example shown in FIG. 16, an interval space 4 is divided into a front interval space, a rear interval space, a left interval space, and a right interval space positioned between the four sides of the insulator 3 and the fixed base 1, and a plurality of conductive terminals 2 in a single row are staggered left and right in pairs.

A front end and a rear end of the fixed base 1 are provided with n-shaped openings 14 respectively, and a front end and a rear end of the insulator 3 are symmetrically provided with a front hanging lug 30 and a rear hanging lug 33 respectively, where the front hanging lug 30 and the rear hanging lug 33 protrude into the n-shaped openings 14 on the front end and the rear end correspondingly. A gap for the front hanging lug 30 to swing is reserved between the front hanging lug 30 and an inner wall of the n-shaped opening 14 on the front end, and a gap for the front hanging lug 30 to swing is reserved between the rear hanging lug 33 and an inner wall of the n-shaped opening 14 on the rear end. The movement of the front hanging lug 30 and the rear hanging lug 33 is limited through an upper edge, a left edge, and a right edge of the n-shaped opening 14 on the front end and an upper edge, a left edge, and a right edge of the n-shaped opening on the rear end respectively. Therefore, a deflection angle range of the insulator 3 is limited in the front-and-rear direction. A left side and a right side of the upper end of the fixed base 1 are provided with a left blocking wall 15 and a right blocking wall 16 respectively. A forward-direction swinging limit of the left blocking edge 34 is limited to the left blocking wall 15, and a reverse-direction swinging limit of the right blocking edge 35 is limited to the right blocking wall 16. Therefore, a deflection angle range of the insulator is limited in the left-and-right direction.

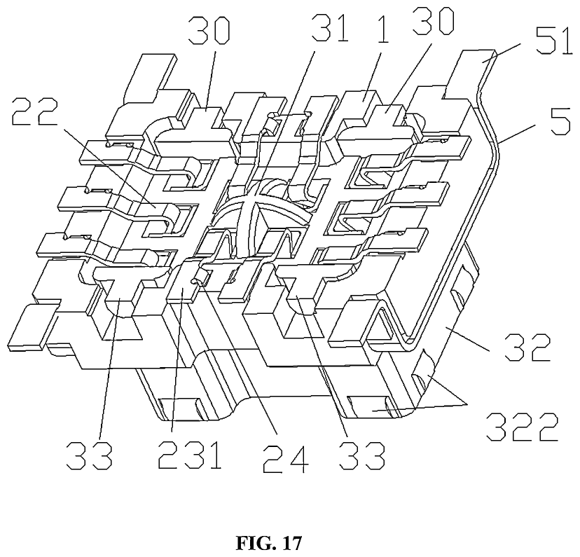

In the example shown in FIG. 17, an interval space 4 is divided into a front interval space, a rear interval space, a left interval space, and a right interval space positioned between the four sides of the insulator 3 and the fixed base 1 respectively, and four rows of conductive terminals 2 are symmetrically arranged in pairs on the front-and-rear side and the left-and-right side of the insulator 3. Limiting structures for limiting a reciprocating deflection angle of the insulator 3 are arranged between the fixed base 1 and the four sides of the insulator 3 respectively. The limiting structures can limit the deflection of the block-shaped insulator 3 based on a height of an inner wall of the fixed base 1. A specific structure is as follows:

A front end and a rear end of the fixed base 1 are provided with two n-shaped openings 14 respectively, a front end and a rear end of the insulator 3 are symmetrically provided with two sets of front hanging lugs 30 and two sets of rear hanging lugs 33 respectively, where the two sets of front hanging lugs 30 and the two sets of rear hanging lugs 33 protrude into the two n-shaped openings 14 on the front end and the two n-shaped openings on the rear end correspondingly. Gaps for the front hanging lugs 30 to swing are reserved between the two sets of front hanging lugs 30 and inner walls of the two n-shaped openings 14 on the front end, and gaps for the front hanging lug 30 to swing are reserved between the two sets of rear hanging lugs 33 and inner walls of the two n-shaped openings 14 on the rear end. The movement of the front hanging lugs 30 and the rear hanging lugs 33 is limited through upper edges, left edges, and right edges of the n-shaped openings 14 on the front end and upper edges, left edges, and right edges of the n-shaped openings on the rear end respectively. Therefore, a deflection angle range of the insulator 3 is limited in the front-and-rear direction. A left side and a right side of the upper end of the fixed base 1 are provided with a left blocking wall and a right blocking wall respectively. A forward-direction swinging limit of a left blocking edge is limited to the left blocking wall, and a reverse-direction swinging limit of a right blocking edge is limited to the right blocking wall. Therefore, a deflection angle range of the insulator is limited in the left-and-right direction.

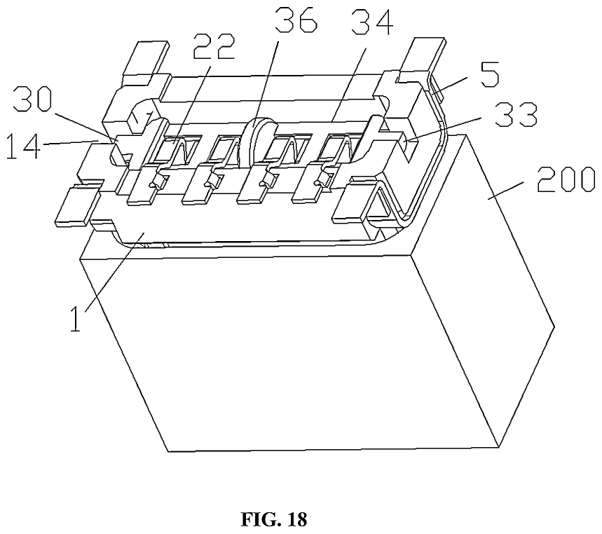

In the example shown in FIG. 18, an interval space 4 is divided into a front interval space, a rear interval space, a left interval space, and a right interval space positioned between the four sides of the insulator 3 and the fixed base 1 respectively, and a single row of conductive terminals 2 are arranged on a left side. Limiting structures for limiting a reciprocating deflection angle of the insulator 3 are arranged between the fixed base 1 and the four sides of the insulator 3.

A front end and a rear end of the fixed base 1 are provided with n-shaped openings 14 respectively, and a front end and a rear end of the insulator 3 are symmetrically provided with a front hanging lug 30 and a rear hanging lug 33 respectively, where the front hanging lug 30 and the rear hanging lug 33 protrude into the n-shaped openings 14 on the front end and the rear end correspondingly. A gap for the front hanging lug 30 to swing is reserved between the front hanging lug 30 and an inner wall of the n-shaped opening 14 on the front end, and a gap for the front hanging lug 30 to swing is reserved between the rear hanging lug 33 and an inner wall of the n-shaped opening 14 on the rear end. The movement of the front hanging lug 30 and the rear hanging lug 33 is limited through an upper edge, a left edge, and a right edge of the n-shaped opening 14 on the front end and an upper edge, a left edge, and a right edge of the n-shaped opening on the rear end respectively. Therefore, a deflection angle range of the insulator 3 is limited in the front-and-rear direction. A left side and a right side of the upper end of the fixed base 1 are provided with a left blocking wall 15 and a right blocking wall 16 respectively. A forward-direction swinging limit of a left blocking edge 34 is limited to the left blocking wall 15, and a reverse-direction swinging limit of a right blocking edge 35 is limited to the right blocking wall 16. Therefore, a deflection angle range of the insulator is limited in the left-and-right direction.

In the examples shown FIGS. 16 and 18, in order to further enhance the stable connection between the fixed base 1 and the connection plate 6, in the present application, the front end and the rear end of the fixed base 1 are provided with supports 5 respectively. The supports 5 are made of metal and in a frame shape. The front end and the rear end of the fixed base 1 are correspondingly sleeved with the frame-shaped supports 5. Vertical frame edges of the two supports 5 are symmetrically clamped into vertical clamping grooves 12 on the front end and the rear end of the fixed base 1. Two ends of each support 5 penetrate the vertical clamping grooves 12 downwards and then are bent and extend horizontally outwards from a lower side of the fixed base 1 in a direction away from the fixed base 1. Lower sides of bent portions of the two ends of each support 5 are provided with support welding portions 51. The stable connection between the fixed base 1 and the connection plate 6 is strengthened by welding the support welding portions 51 on the two ends of the support 5 to the connection plate 6.

It can be seen from the above that the limiting structures may employ various structural designs. The change in the limiting structures is not to limit the scope of protection of the present application. For example, the four sides of the insulator 3 may be provided with blocking edges respectively, and inner walls of four sides of the deflection space 11 are blocking walls. When the insulator 3 deflects in the front-and-rear direction, the blocking edges on the front side and the rear side of the insulator 3 abut against the inner walls on the front side and the rear side of the deflection space 11 on the swinging limit, so that the deflection angle range of the insulator 3 is limited in the front-and-rear direction; and the blocking edges on the left side and the right side of the insulator 3 abut against the inner walls on the left side and the right side of the deflection space 11 on the swinging limit, so that the deflection angle range of the insulator 3 is limited in the left-and-right direction.

It can be seen from the above that the size of the interval space 4 may be adjusted as required in practice. The size of the interval space 4 is related to the size of the connector, the size of the insulator, and the material and structural improvements of the flexible portion 22 on the conductive terminal. The selection of the size of the interval space 4 is not to limit the scope of protection of the present application.

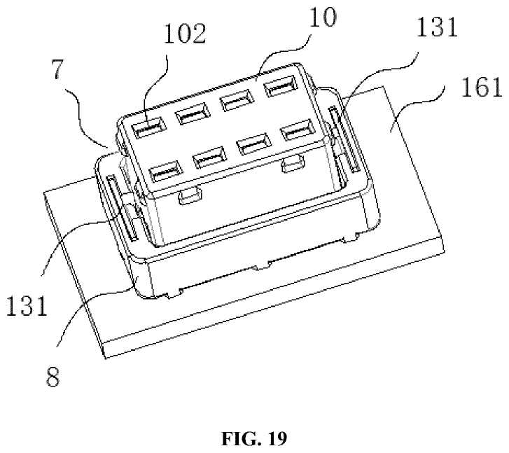

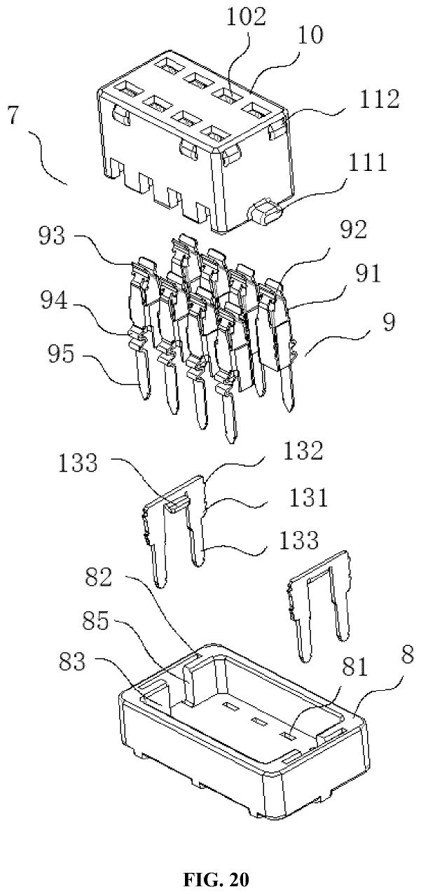

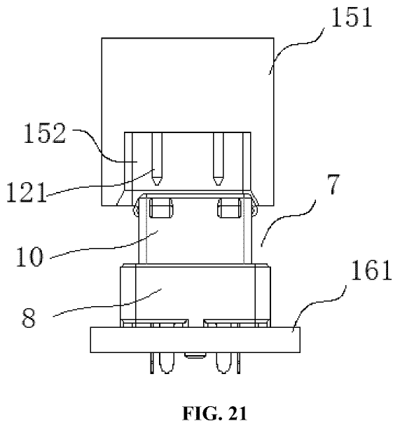

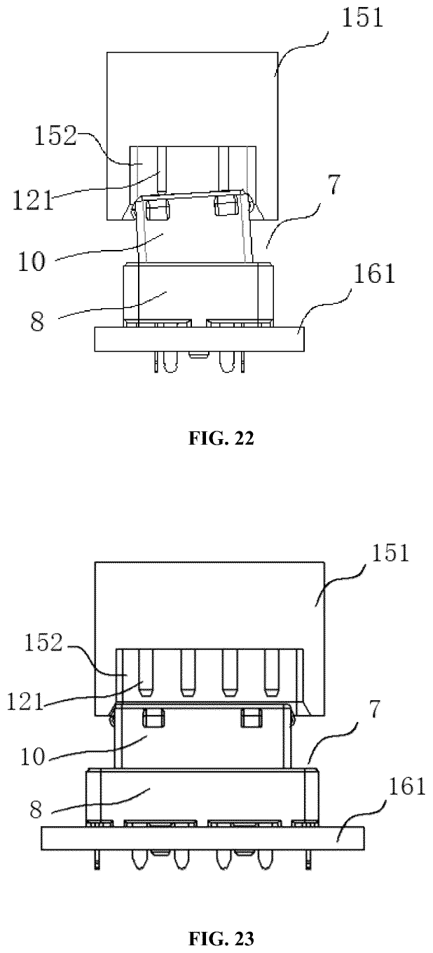

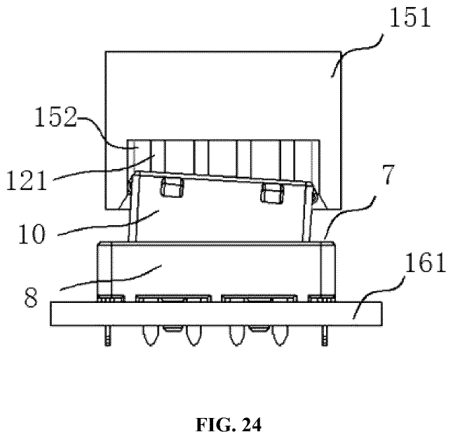

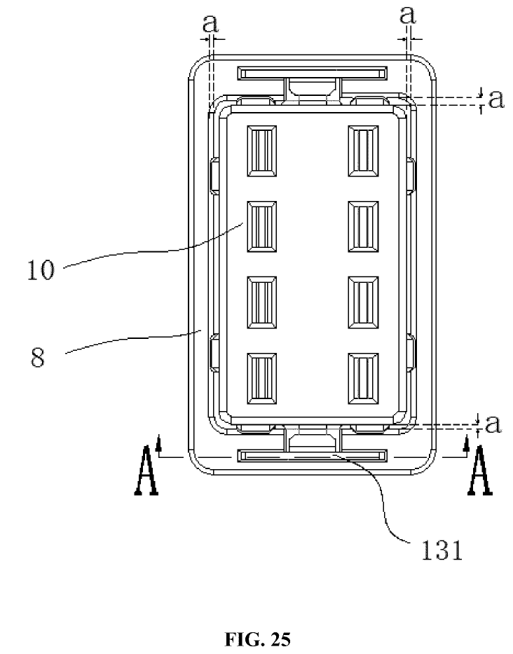

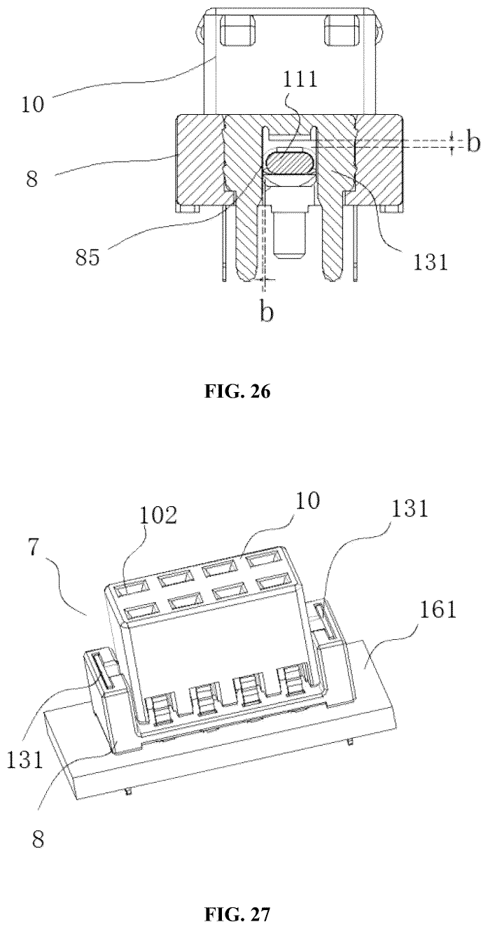

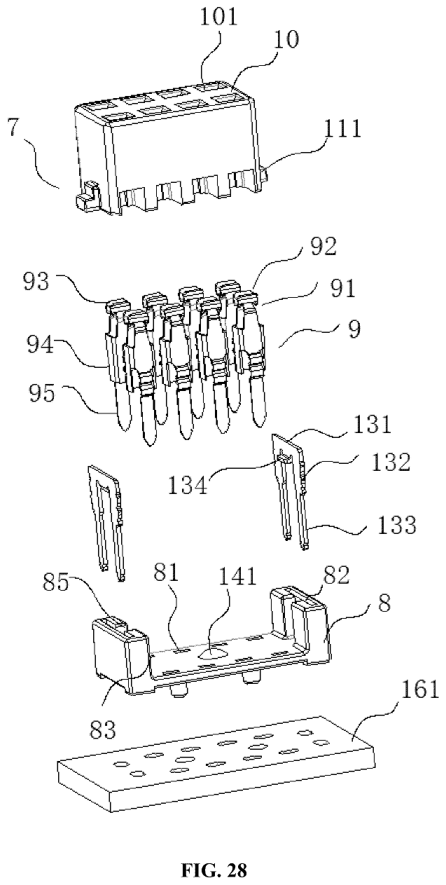

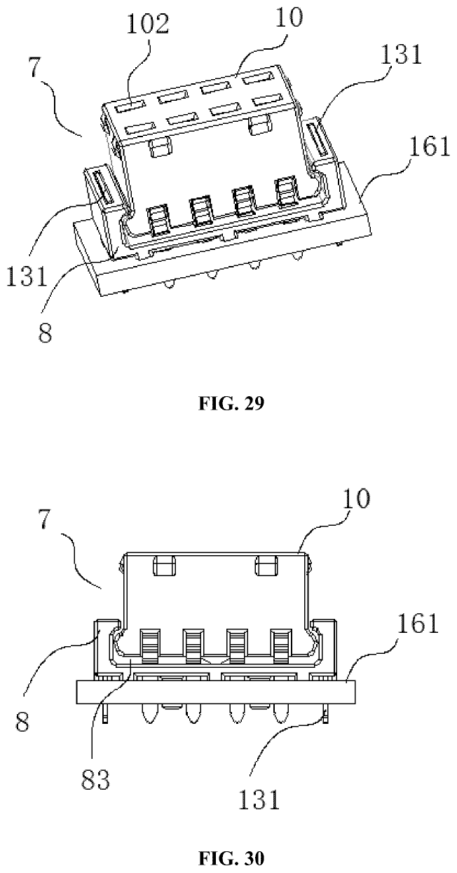

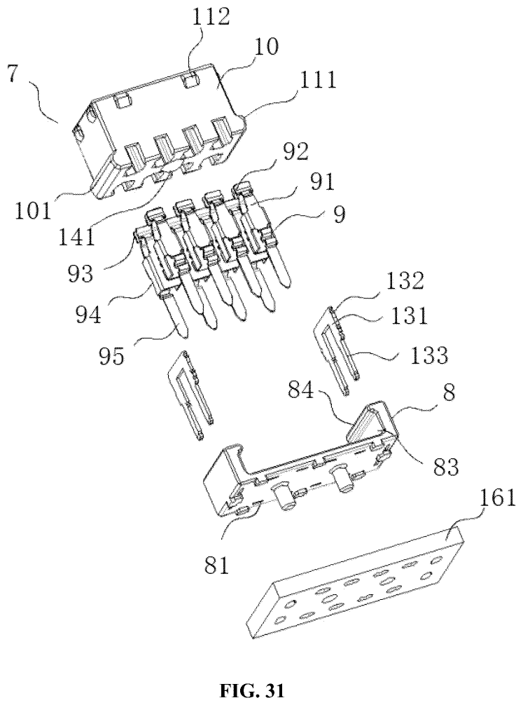

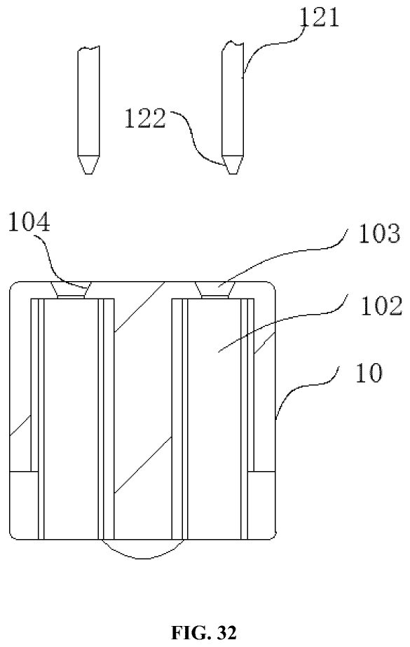

With reference to FIGS. 19-32, a swingable error-tolerant floating connector realizing mating guide for conductive terminals includes a connector 7 and an external insert 151.

The connector 7 is fixedly mounted on a substrate 161, and the external insert 151 establishes insert connection to the connector 7, so as to be electrically connected to the substrate 161.

In the present application, a lower end of a plug head of the external insert 151 is provided with a recess 152, and the recess 152 is configured to movably sleeve a floating insulator. Second conductive terminals 121 are fixedly arranged in the external insert 151, and end sockets configured for insert connection of the plurality of second conductive terminals 121 are positioned in the recess 152.

In the present application, the connector 7 includes a fixed base 8, first conductive terminals 9, and a floating insulator 10. The floating insulator is provided with a plurality of insertion holes 102, and the first conductive terminals 9 are fixedly clamped into the insertion holes 102. The plurality of second conductive terminals 121 correspond one-to-one to a plurality of first conductive terminals 9. During mating, the second conductive terminals 121 may be inserted into the insertion holes 102 and establishes insert connection to the first conductive terminals 9.

In the present application, the first conductive terminal 9 is divided into an insertion body 91, a flexible portion 95, and a conductive terminal pin 96 in sequence from top to bottom. The floating insulator 10 is floatingly supported on the fixed base 8 through the insertion body 91, the flexible portion 95, and the conductive terminal pin 96.

The insertion body 91 is clamped into the insertion hole 102 through concave-and-convex fit. Changes in the clamping fixing structure of the concave-and-convex fit and the structure of the first conductive terminal 9 do not affect the scope of protection of the present application.

In the present application, the fixed base 8 is provided with a plurality of fixed base holes 81 in a circumferential direction, a plurality of conductive terminal pins 96 penetrate the corresponding insertion holes 102 and then are clamped into the fixed base holes 81 respectively, and the conductive terminal pins 96 penetrate the fixed base holes 81 and then are welded to the substrate 161. The fixed base holes 81 cooperate with the conductive terminal pins 96, so as to maintain the arranged positions of the floating insulator 10, the first conductive terminals 9, and the fixed base 8.

In the present application, a support 131 is further arranged between the fixed base 8 and the substrate 161, protruding portions 132 are arranged on a left side and a right edge of the support 131, and the support 131 is clamped into a clamping groove 82 on the fixed base 8 through the protruding portions 132. Support welding pins 133 are arranged on a lower end of the support 131, the support welding pins 133 are welded to the substrate 161, and the support is configured to maintain the fixed position of the fixed base on the substrate 161.

In the example of the present application, an inner recess body 83 is formed in the middle of the upper end of the fixed base 8, and the block-shaped floating insulator 10 is floatingly arranged in the inner recess body 83. Floating gaps a for the floating insulator 10 to shift are reserved between four sides of the block-shaped floating insulator 10 and an inner wall of the inner recess body 83, and the floating gaps a are configured to limit left-and-right swinging and floating of the floating insulator 10.

A further improvement on the inner recess body 83 in Example 4 is as follows: notches 85 are provided on a front short edge recess wall and a rear short edge recess wall of the inner recess body 83 respectively, and the notches 85 enable communication between the clamping grooves 82 and the inner recess body 83. A front end and a rear end of the block-shaped floating insulator 10 are provided with insulator hanging lugs 111 respectively. The insulator hanging lugs 111 are floatingly arranged in the notches 85. Blocking edges 134 bent towards the notches 85 are arranged on the support 131, and the blocking edges 134 and left sides, right sides, and bottom sides of the notches 85 jointly form a floating interval for limiting swinging and floating of the insulator hanging lugs 111. In the floating interval, sufficient floating intervals b for the insulator hanging lugs 111 to swing and float are reserved between four sides of the insulator hanging lugs 111 and the left sides, right sides, and bottom sides of the notches 85 as well as the blocking edges 134 respectively. The floating intervals b are configured to limit up-and-down swinging and floating of the floating insulator 10.

Sloped guide structures capable of converting interaction forces between the second conductive terminals 121 and the insertion holes 102 into forces to push the floating insulator 10 to be adjusted floatingly during cooperation are arranged between the second conductive terminals 121 and the insertion holes 102, so as to perform mating guide on the end sockets configured for insert connection of the second conductive terminals 121. The sloped guide structure includes a first sliding guide structure 103, where the first sliding guide structure 103 is a through hole section having a larger opening on an upper end and a smaller opening on a lower end on the insertion hole 102. A sloped sliding guide surface 104 having an inner diameter gradually decreased is arranged between an upper end and a lower end of a through hole. Expect for the sloped sliding guide surface, a cambered sliding guide surface may also be employed to replace the sloped sliding guide surface to realize sliding guide. The change in the shape of the sliding guide surface does not affect the scope of protection of the present application.

The second conductive terminal 121 is an insertion pin, and a top end of the insertion pin is provided with an inclined sliding guide surface 122 configured to guide the insertion pin into the insertion hole.

For example, the second conductive terminal 121 is a cylindrical insertion pin, and the top end of the cylindrical insertion pin is an inverted tapered body. The inclined sliding guide surface 122 on the periphery of the inverted tapered body is in sliding fit with the sloped sliding guide surface 104 on an inner wall of the first sliding guide structure 103, so as to realize the sliding guide effect in the mating process. In a sliding process, the first sliding guide structure 103 floats towards one side after being pressed by the sloped sliding guide surface 104. Therefore, the interaction force can be converted into the force to push the floating insulator 10 to float and to be adjusted towards one side during butt-joint cooperation. After the floating insulator 10 is adjusted, the plurality of second conductive terminals 121 can be smoothly axially inserted into the corresponding insertion holes 102.

In the example of the present application, the insertion body 91 is provided with gripping portions 92 capable of gripping insertion portion of the second conductive terminal 121 to maintain the electric connection during mating, so as to ensure the stability of mating electric connection between the terminals. A structure of the gripping portion 92 is as follows: a plurality of elastic terminal sheets 93 are arranged on an upper end of the insertion body 91, and middles of the elastic terminal sheets 93 are bent towards the centers; every two of the plurality of elastic terminal sheets 93 form a group, and the elastic terminal sheets 93 in each group are arranged oppositely in a circumferential direction; and receiving cavities for the second conductive terminals 121 to be inserted are formed between the plurality of terminal leaf springs 93, and the middles of the plurality of elastic terminal sheets 93 are bent towards the centers to form the gripping portions 92. Through such a structural design, the receiving cavity is provided with an accommodation space having larges openings on an upper end and a lower end and a small inner diameter in the middle, so that stable electrical connection between the connector 7 and the external insert 151 is ensured.

During specific implementation, except for the two elastic terminal sheets arranged, a plurality of pairs, for example, two pairs or three pairs, of elastic terminal sheets may also be arranged. The change in the number of elastic terminal sheets is not to limit the scope of protection of the present application.

In order to facilitate free rotation and swinging of the floating connector 10 relative to the external insert 151 in the mating process, in the example of the present application, a cambered guide structure or a sloped guide structure further includes a second sliding guide structure 103. The second sliding guide structure 103 is configured in such a way that a protrusion 33 configured to guide the floating insulator 10 into the recess 152 arranged on the lower end of the external insert 151 is arranged on an upper end of the floating insulator 10, and top ends of a plurality of protrusions 33 form a spherical crown structure capable of sliding along an inner wall of the recess 152 and being in rotating and swinging fit in the recess 152. During mating, the external insert firstly presses the cambered sliding surfaces outside the protrusions 112 on a head portion of the floating insulator 10 through the spherical crown structure, and the floating insulator 10 deflects by an angle under action of the external insert 151. Therefore, the plurality of second conductive terminals 121 are guided to be smoothly inserted into the insertion holes, the floating insulator 10 adjusts an angle and a position relative to the external insert 151 during the insert connection, and the floating insulator 10 is prevented from being stuck by the recess 152 of the external insert 151 during mating.

In the example of the present application, a bottom of the floating insulator 10 is provided with a spherical support point 141 for supporting the floating insulator to perform angular deflection and restoration. The spherical support point 141 is configured to support the floating insulator in a height direction and protect the first conductive terminals 9. Accordingly, the floating insulator 10 can be supported to perform the angular deflection and restoration while the floating insulator 10 is presented from being pressed downwards during mating and damaging the welding spots on the first conductive terminals 9. The spherical support point 141 may be arranged on the fixed base 8 or on the floating insulator 10.

The spherical support point 141 is positioned at the center of a bottom of the inner recess body 83 of the fixed base 8, and the spherical support point 141 and the fixed base 8 are of an integral structure formed through injection molding.

The spherical support point 141 is positioned at the center of the bottom of the floating insulator 10, and the spherical support point 141 and the floating insulator 10 are of an integral structure formed through injection molding.

Except for the structure of the support 131 in Examples 4 and 5, the shift of the floating insulator 10 may also be limited by improving the structure of the inner recess body 83 in the present application. For example, as shown in Example 6 of the present application, bottoms of the front end and the rear end of the floating insulator 10 are provided with lower limiting bars 101 protruding outwards in a direction of two short edges respectively, and the tops of recess walls on a front end and a rear end of the inner recess body 83 on the fixed base 8 are provided with upper limiting bars 84 protruding from the recess walls in a direction of two short edges respectively. The upper limiting bars 84 and the lower limiting bar 101 are arranged at intervals in a vertical direction. In the rotating and swinging process of the floating insulator 10 in the front-and-rear direction, the upper limiting bars 84 can limit the upward limit rotating and swinging positions of the lower limiting bars 101. Simultaneously, the downward limit rotating and swinging positions of the lower limiting bars 101 are limited by the recess walls on the front end and the rear end of the inner recess body 83. Compared with Examples 4 and 5, through such a structural design, it is not required to make communication between the inner recess body 83 and the clamping groove 82 where the support 131 is positioned or cut and bend the support 131 to form a baffle. Through the structural design in Example 5, the structure of the support 131 is further simplified, but the structures of the inner recess body 83 and the floating insulator 10 are complicated.

Except for the modified structure of the inner recess body 83 in Examples 4 and 6, the inner recess body 83 may also be implemented in another structure in the present application. For example, Example 5 is further improved based on Example 4: Based on the structure of the inner recess body 83 designed in Example 4, the inner recess body 83 can be further simplified. For example, only the recess walls arranged along the short edges on the front end and the rear end of the inner recess body 83 are kept. In this case, the rotation and swinging of the floating insulator 10 in the left-and-right direction is not limited by the inner recess body 83, and thus the floating insulator 10 has higher error-tolerant butt-joint performance in the left-and-right direction.

Working principles in Examples 4, 5, and 6 of the present application are as follows: In the non-coaxial eccentric state, the external insert 151 presses the protrusions 112 on the head portion of the floating insulator 10, and the floating insulator 10 deflects by an angle under the action of the external insert 151; and then the sloped sliding guide surfaces 104 on the insertion holes 102 cooperate with the inclined sliding guide surfaces 122 on the top ends of the insertion pins to further guide the second conductive terminals 121 to be axially inserted into the insertion holes 102. Therefore, the plurality of second conductive terminals 121 can be smoothly inserted into the insertion holes 102. When the second conductive terminals 121 establish insert connection to the first conductive terminals 9 in the insertion holes 102, all the second conductive terminals 121 and the gripping portions 92 on the first conductive terminals 9 keep a pressing attachment state, so that the stable electric connection between the connector 7 and the external insert 151 can be ensured.

While the examples of the present application have been shown and described, it can be understood by those of ordinary skill in the art that various changes, modifications, substitutions, and variations can be made to these examples without departing from the principles and spirit of the present application, and the scope of the present application is defined by the appended claims and their equivalents.

The above examples are merely used for illustrating, rather than limiting the technical solutions of the present application; under the ideas of the present application, the above embodiments or the technical features in different embodiments can also be combined, the steps can be implemented in any order, and there are many other changes in different aspects of the present application as described above, which are not provided in detail for simplicity; although the present application is described in detail with reference to the foregoing embodiments, those of ordinary skill in the art should understand that they can still modify the technical solutions recorded in the foregoing embodiments or equivalently replace some of the technical features; and these modifications or replacements do not make the essences of the corresponding technical solutions deviate from the scope of the technical solutions of the embodiments of the present application.

What is claimed is:

1. A swingable error-tolerant connector, comprising a fixed base, an insulator, and a conductive terminal, wherein the insulator is floatingly supported on the fixed base through the conductive terminal, and a flexible portion for floatingly supporting the insulator to translate and/or swing is arranged on the conductive terminal.

2. The swingable error-tolerant connector according to claim 1, wherein a bottom of the insulator is provided with a cambered support point or a spherical support point for supporting the insulator to perform angular deflection and restoration.

3. The swingable error-tolerant connector according to claim 2, wherein an upper end of the insulator is provided with an end socket configured to establish insert connection to an external insert, the end socket is provided with an insert connection hole, the end socket is provided with a bigger end, and a periphery of the bigger end is in a spherical crown shape; and when the external insert is guided to establish insert connection to the end socket through the bigger end, the end socket is swingable in the external insert through a spherical crown surface of the bigger end, so that an insert angle of the end socket is adjustable.

4. The swingable error-tolerant connector according to claim 3, wherein the conductive terminal is divided into a terminal insertion body, the flexible portion, and a terminal pin in sequence from top to bottom, and the terminal pin is provided with a retaining portion capable of being inserted into the fixed base;
the insertion body is fixedly mounted in the insert connection hole, and an elastic female terminal contact sheet on an upper end of the insertion body is arranged in the insert connection hole and is close to an upper port of the insert connection hole;
the elastic female terminal contact sheet on the insertion body is an elastic female terminal contact sheet with offset tolerance; and a specific structure is configured in such a way that an upper end of the conductive terminal is provided with elastic terminal sheets oppositely arranged, a receiving cavity provided with two opposite side openings for terminals of the external insert to be inserted is formed between the elastic terminal sheets, and an interval between the elastic terminal sheets oppositely arranged is formed into a female terminal tolerance interval capable of tolerating an error of insert connection of the terminals of the external insert.

5. The swingable error-tolerant connector according to claim 4, wherein the insertion body is provided with a clamping portion capable of being clamped into the insert connection hole, and a fastening structure for reinforcing the clamping portion is arranged between one side of an outer wall of the clamping portion and an inner wall of the insert connection hole.

6. The swingable error-tolerant connector according to claim 5, wherein the fastening structure is a protrusion, and a plurality of protrusions are arranged at intervals in a vertical direction along the clamping portion.

7. The swingable error-tolerant connector according to claim 4, wherein the flexible portion is an elastic welding pin sheet having a flexible deformation structure, and the elastic welding pin sheet is bent in a right angle, an acute angle, a single wave, or multiple waves.

8. The swingable error-tolerant connector according to claim 2, wherein an upper end of the insulator is provided with an end socket configured to establish insert connection to an external insert, the end socket is provided with an insert connection hole, and four sides of the end socket are provided with protruding cambered guide structures configured to guide the external insert to establish insert connection to the end socket respectively; a plurality of cambered guide structures form a spherical crown surface structure capable of being in sliding fit with the external insert; and when the external insert is guided to establish insert connection to the end socket through the cambered guide structures, the end socket is swingable in the external insert through the spherical crown surface structure formed by the plurality of cambered guide structures, so that an insert angle of the end socket is adjustable.

9. The swingable error-tolerant connector according to claim 8, wherein the conductive terminal is divided into a terminal insertion body, the flexible portion, and a terminal pin in sequence from top to bottom, and the terminal pin is provided with a retaining portion capable of being inserted into the fixed base;
the insertion body is fixedly mounted in the insert connection hole, and an elastic female terminal contact sheet on an upper end of the insertion body is arranged in the insert connection hole and is close to an upper port of the insert connection hole;
the elastic female terminal contact sheet on the insertion body is an elastic female terminal contact sheet with offset tolerance; and a specific structure is configured in such a way that an upper end of the conductive terminal is provided with elastic terminal sheets oppositely arranged, a receiving cavity provided with two opposite side openings for terminals of the external insert to be inserted is formed between the elastic terminal sheets, and an interval between the elastic terminal sheets oppositely arranged is formed into a female terminal tolerance interval capable of tolerating an error of insert connection of the terminals of the external insert.

10. The swingable error-tolerant connector according to claim 9, wherein the insertion body is provided with a clamping portion capable of being clamped into the insert connection hole, and a fastening structure for reinforcing the clamping portion is arranged between one side of an outer wall of the clamping portion and an inner wall of the insert connection hole.

11. The swingable error-tolerant connector according to claim 10, wherein the fastening structure is a protrusion, and a plurality of protrusions are arranged at intervals in a vertical direction along the clamping portion.

12. The swingable error-tolerant connector according to claim 10, wherein the flexible portion is an elastic welding pin sheet having a flexible deformation structure, and the elastic welding pin sheet is bent in a right angle, an acute angle, a single wave, or multiple waves.

13. The swingable error-tolerant connector according to claim 1, wherein the fixed base is provided with a deflection space for the insulator to deflect, the insulator is suspended in the deflection space, and an interval space for the insulator to deflect in a reciprocating manner is provided between the insulator and the fixed base.

14. The swingable error-tolerant connector according to claim 13, wherein the interval space is divided into a front interval space, a rear interval space, a left interval space, and a right interval space positioned between four sides of the insulator and the fixed base respectively, and limiting structures for limiting a reciprocating deflection angle of the insulator is arranged between the fixed base and the four sides of the insulator respectively.

15. A swingable error-tolerant floating connector realizing mating guide for conductive terminals, comprising a connector and an external insert; wherein the connector comprises a floating insulator, a plurality of insertion holes are provided on the floating insulator, and first conductive terminals are fixedly clamped into the insertion holes; the external insert is provided with second conductive terminals capable of being inserted into the insertion holes and being in insert connection to the first conductive terminals, and the plurality of second conductive terminals correspond one-to-one to the plurality of first conductive terminals; and cambered guide structures or sloped guide structures capable of converting interaction forces between the second conductive terminals and the insertion holes into forces to push the floating insulator to be adjusted floatingly during cooperation are arranged between the second conductive terminals and the insertion holes.

16. The swingable error-tolerant floating connector realizing mating guide for conductive terminals according to claim 15, wherein the cambered guide structure or the sloped guide structure comprises a first sliding guide structure; and the first sliding guide structure is configured in such a way that a through hole section having a larger opening on an upper end and a smaller opening on a lower end is provided on the insertion hole, and a cambered sliding guide surface or a sloped sliding guide surface having an inner diameter gradually reduced is arranged between an upper end and a lower end of a through hole.

17. The swingable error-tolerant floating connector realizing mating guide for conductive terminals according to claim 16, wherein the second conductive terminal is an insertion pin, and a top end of the insertion pin is provided with an inclined sliding guide surface configured to guide the insertion pin into the insertion hole.

18. The swingable error-tolerant floating connector realizing mating guide for conductive terminals according to claim 16, wherein the first conductive terminal is provided with a gripping portion capable of gripping an insertion portion of the second conductive terminal to maintain electrical connection during cooperation.

19. The swingable error-tolerant floating connector realizing mating guide for conductive terminals according to claim 15, wherein the cambered guide structure or the sloped guide structure further comprises a second sliding guide structure; and the second sliding guide structure is configured in such a way that a protrusion is arranged on an upper end of the floating insulator and configured to guide the floating insulator into a recess on a lower end of the external insert, and a plurality of protrusions form a spherical crown structure capable of being in movable fit with the recess.

20. The swingable error-tolerant floating connector realizing mating guide for conductive terminals according to claim 15, wherein a bottom of the floating insulator is provided with a spherical support point for supporting the floating insulator to perform angular deflection and restoration.

21. The swingable error-tolerant floating connector realizing mating guide for conductive terminals according to claim 20, wherein the spherical support point and the fixed base are of an integral structure formed through injection molding.

22. The swingable error-tolerant floating connector realizing mating guide for conductive terminals according to claim 20, wherein the spherical support point and the floating insulator are of an integral structure formed through injection molding.
